(19) United States
(12) Patent Application Publication
(10) Pub. No.: US 2013/0180159 A1
(43) Pub. Date: Jul. 18, 2013

(54) FISHING JIG INCLUDING IMPROVED HEAD, WEED GUARD, AND ADJUSTABLE FALL FEATURES

(71) Applicant: Scott Smith, Boaz, AL (US)

(72) Inventor: Scott Smith, Boaz, AL (US)

(21) Appl. No.: 13/741,023

(22) Filed: Jan. 14, 2013

Related U.S. Application Data
(60) Provisional application No. 61/586,529, filed on Jan. 13, 2012.

(51) Int. Cl. A01K 85/02; A01K 99/00; A01K 85/00; A01K 83/00

(52) U.S. Cl. CPC A01K 85/02; A01K 83/00; A01K 99/00; A01K 85/00
USPC 43/42.22; 43/44.81; 43/42.7; 43/4.5; 43/42.4

(57) ABSTRACT

Various embodiments provide fishing jig having improved head, weed guard, and adjustable fall features. Trailing weights are adjustable in size and/or position within the jig, provide for adjustment of the fall characteristics of a given jig for a given situation. Movement of weights forward along the jig cause the jig to fall more forwardly, and vice versa. All else being the same, increasing size of weights at a given position on the rear of the jig cause the jig to fall more rearwardly, and vice versa. Thus a rear weight that can be adjusted in size, shape, and position or completely removed and reused, without destroying the jig or weight system. Also provided is a wire coil and a skirt-mounting collar on the same lure, providing improved weedless capability. Also provided is a jig with a “dropped” line attachment eye, giving an upward movement when the lure is pulled in.

### CROSS-REFERENCE TO RELATED APPLICATIONS

This application claims priority to and the benefit of U.S. Application No. 61/586,529 entitled, “Fishing Jig Including Improved Head and Weed Guard” that was filed on Jan. 13, 2012, the entirety which is hereby incorporated by reference herein.

### BACKGROUND

1. Technical Field

Embodiments of the present invention relate generally to fishing, and in particular to the use of fishing jigs.

2. Description of Related Art

Fishing jigs are well known in the art. Examples are U.S. Des. Pat. No. 299,944, U.S. Des. Pat. No. 257381, U.S. Des. No. 216881, and U.S. Pat. No. 5,245,783. However, improvements are always welcome.

### BRIEF SUMMARY OF VARIOUS EMBODIMENTS OF THE INVENTION

Various embodiments of the present invention provide an improved fishing jig. Various embodiments of the present invention still further provide an improved fishing jig that includes improved fall characteristics. Various embodiments of the present invention still further provide an improved fishing jig that includes adjustable fall characteristics.

Generally described, according to various embodiments, a fishing element is provided, configured to be pulled along a pulling axis, the fishing element comprising: a hook element, the hook element including an elongate hook portion having a component along the pulling axis, the elongate hook portion including forward and rearward segments being at differing positions relative to the pulling axis, the forward hook shank segment being positioned more forwardly than the forward hook shank segment; a trailing weight element; and a connection element for connecting the hook relative to the the weight, the connection element including an connecting segment configured to be movably attached relative to either of the forward and rearward segments, such that the center of gravity of the fishing element can be adjusted along the length of the pulling axis by moving the connection element back and forth between attachment with the forward and rearward segments.

According to various related embodiments, the weight element is the only weight element attached to the connection element.

According to various related embodiments, the connection element includes an intermediate elongate flexible portion which interconnects its connecting segment to the trailing weight element, such that the weight is spaced from the hook.

According to various related embodiments, the connector attaches to the hook between the hook eye and the turnback point of the hook, such that gravity on the weights tends to keeps the hook point up.

According to various related embodiments, the connector attaches to the hook between the hook eye and the turnback point of the hook, such that gravity on the weights tends to keeps the hook point up.

According to various related embodiments, the elongate hook portion lies substantially in a plane; wherein the weight element is a first weight element attached to the connection element, and further comprising a second weight element attached to the connection element such that two weight elements are spaced apart and on different sides of the plane of the hook.

According to various related embodiments, each connection element includes an intermediate elongate flexible portion which interconnects its connecting segment to the trailing weight element, such that each weight is spaced from the hook.

According to various embodiments, a fishing element is configured to be pulled along a pulling axis, the fishing element comprising: a hook element, the hook element including an eye, and also including an elongate hook portion spaced from the eye and having a component along the pulling axis, the elongate hook portion including forward and rearward segments being at differing positions relative to the pulling axis, the forward hook shank segment being positioned more forwardly than the forward hook shank segment; a jig head of a predetermined weight, the jig head attached to the hook element proximate the eye; a trailing weight element; and a connection element for connecting the hook relative to the weight, the connection element including a elongate hook portion connecting end configured to be movably attached relative to either of the forward and rearward segments, such that the center of gravity of the fishing element can be adjusted along the length of the pulling axis by moving the connection element back and forth between attachment with the forward and rearward segments.

According to various related embodiments, the weight element is the only weight element attached to the connection element.

According to various related embodiments, the connection element includes an intermediate elongate flexible portion which interconnects its connecting segment to the trailing weight element, such that the weight is spaced from the hook.

According to various related embodiments, the connector attaches to the hook between the hook eye and the turnback point of the hook, such that gravity on the weights tends to keeps the hook point up.

According to various related embodiments, the connector attaches to the hook between the hook eye and the turnback point of the hook, such that gravity on the weights tends to keeps the hook point up.

According to various related embodiments, the elongate hook portion lies substantially in a plane; wherein the weight element is a first weight element attached to the connection element, and further comprising a second weight element attached to the connection element such that two weight elements are spaced apart and on different sides of the plane of the hook.

According to various related embodiments, each connection element includes an intermediate elongate flexible portion which interconnects its connecting segment to the trailing weight element, such that each weight is spaced from the hook.

According to various embodiments, a method is provided of adjusting the drop characteristics of a fishing element configured to be cast into water, allowed to drop, and then pulled along a pulling axis, the method comprising the steps of: A) Providing a fishing element, the fishing element comprising: a hook element, the hook element including an eye, and also including an elongate hook portion spaced from the eye and having a component along the pulling axis, the elongate hook portion including forward and rearward segments being at differing positions relative to the pulling axis, the forward hook shank segment being positioned more forwardly than the forward hook shank segment; a jig head of a predetermined weight, the jig head attached to the hook element proximate the eye; a trailing weight element; and a connection element connecting the hook relative to the weight, the connection element including an elongate hook portion connecting portion configured to be movably attached relative to either of the forward and rearward segments; and B) adjusting the fall of the fishing element by adjusting the position of the connection element back and forth along the length of the elongate hook portion.

According to various related embodiments, Step “B” also includes the step of adjusting the weight of the trailing weight element:

According to various embodiments, a fishing element is configured to be pulled along a pulling axis, the fishing element comprising: a hook element comprised of an elongate bent member, the hook element including an eye, a shank portion, a bend portion and a point, the elongate bent member extending from the eye at one end, to the shank portion, to the bend portion, and terminating in the point at its other end; a jig head of a predetermined weight, the jig head attached to the hook element proximate the eye, the jig head including a skirt mounting section attached to the hook element on the opposite side of the eye; a skirt mounting section attached to the hook element, the skirt mounting section mounted adjacent the jig head such that the jig head is intermediate the skirt mounting section and the eye; a skirt for attaching to the skirt mounting section; and a wire coil extending from the jig head generally towards the hook point, the wire coil configured for engaging a trailer.

According to various related embodiments, the fishing element further comprises a trailer having and elongate portion with two ends, one end engaged with the wire coil and one end engaged with the hook point, such that the trailer provides a weedless feature.

According to various related embodiments, the fishing element further comprises a crawfish-shaped trailer having and elongate portion with two ends, one end engaged with the wire coil and one end engaged with the hook point, such that the trailer provides a weedless feature, and such that the crawfish shape tends to imitate a “defensive” crawfish position when the fishing element is positioned on the water body bottom.

According to various related embodiments, the jig head is one of a swim jig head or a “football” head.

According to various related embodiments, the hook element includes a substantially straight wire shank portion, around which the jig head is molded, with the eye extending away from one side of the jig head at a 10 degree angle away from the bend side of the hook, and wherein hook element includes a wire portion extending out of the other side of the molded jig head at a 20 degree angle, such that the hook at the eye is about 20 degrees down, the wire then goes straight, then drops about 10 degrees down, then starts in a upward wide bend coming back around, with the hook point pointing directly at the wire coil.

According to various embodiments, a fishing element is configured to be pulled along a pulling axis, the fishing element comprising: a hook element comprised of an elongate bent member, the hook element including an eye, a shank portion, a bend portion and a point, the elongate bent member extending from the eye, to the shank portion, to the bend portion, and terminating in the point; a jig head of a predetermined weight, the jig head attached to the hook element proximate the eye; a skirt mounting section attached to the hook element, the skirt mounting section mounted adjacent the jig head such that the jig head is intermediate the skirt mounting section and the eye; a skirt for attaching to the skirt mounting section; and a wire coil extending from the jig head generally towards the hook point, the wire coil configured for engaging a trailer.

### BRIEF DESCRIPTION OF THE SEVERAL VIEWS OF THE DRAWING(S)

The accompanying drawings incorporated herein and forming a part of the disclosure illustrate several aspects of the present invention and together with the detailed description serve to explain certain principles of the present invention. In the drawings, which are not necessarily drawn to scale:

FIG. 1 shows a “football” hook assembly 20 (first hook assembly embodiment), with a trailing weight assembly 70 according to one embodiment of the present invention attached thereto. In this drawing the trailing weight assembly 70 is shown at one position along the length of the shaft of the hook assembly, however as will be discussed later other positions are feasible depending on the action desired.

FIG. 2 shows the hook assembly 20 with a trailing weight assembly 70 according to one embodiment of the present invention attached thereto. In this drawing also is shown in dotted line an exemplary trailer 40 (in this case a crawfish embodiment). As may be seen the trailer 40 is attached at two engagement locations (an upper engagement location 42 and a lower engagement location 44), respectively engaged by the wire coil 28, and the hook point 24.

FIG. 3 is an isolated view of a “swim jig” hook assembly 120 (note that this embodiment is different from the “football” hook assembly 20 in that the lead head is shaped differently, but otherwise the elements are the same as the hook assembly 20). For example, hook point 24 of assembly 20 in FIG. 2 corresponds to hook point 124 of assembly 120. If the hook eye of assembly 20 were numbered, it would be numbered 26, to correspond to hook eye 126 of assembly 120. This general element is sometimes referenced in the industry as a “jig head”. Note the “turn back” point 123 of the bare wire portion—this is the point that the wire turns back and starts extending forward, when the wire is followed from the hook eye.

FIG. 4 is a marked up photograph of an overall jig assembly 10, which includes a hook assembly 20, a trailer 40, and a skirt assembly 60. A dual trailing weight assembly 70 is typically attached, but is not shown in this figure.

FIG. 5 is an isolated view of a rattler assembly 50.

FIG. 6 is a partial view of the “swim jig” hook assembly 120, shown with other elements attached thereto, some of which are shown in cross section. It should be understood that the elements attached thereto (the rattler assembly and the skirt-related elements) could also be similarly attached to the “football” hook assembly 20 (as in FIG. 4) or similarly attached to the “swim jig” hook assembly 220 or the “football” hook assembly 320, the latter of which are described in more detail below.

FIG. 7 is another partial view of the hook assembly 120 of FIG. 6, showing the use of lead to encase and affix the wire coil 28 in place according to one embodiment of the present invention. This use could also apply to the other hook assemblies 120, 220, and 320.

FIG. 8 is an isolated view of a trailing weight assembly 70 according to one embodiment of the present invention. An exemplary hook assembly 20 is also shown in phantom, any of the assemblies 20, 120, 220, or 320 could be included.

FIG. 9 is an isolated view of a weight 72 included in the assembly 70, as it is attached to a connection cord 76 also included in the assembly 70. As may be seen, the connection cord 76 includes an integral cup which snap-fits over a head defined at one end of the weight 72. Glue and also be used in combination with the snap fit.

FIG. 10 is a side elevational view of a “football” hook assembly 220 (third embodiment). This assembly is similar to “football” hook assembly 20 (first embodiment) except that the wire encased in the lead is bent differently, as will be discussed later in reference to FIG. 16.

FIG. 11 is a side elevational view of a “swim jig” hook assembly 320 (fourth embodiment). This assembly is similar to “swim jig” hook assembly 120 (second embodiment) except that the wire encased in the lead is bent differently, as will be discussed later in reference to FIG. 17.

FIG. 12 is an isolated view of double (aka “dual”) trailing weight assembly 70, which includes a securement band 74, connection cords 76, and two trailing weights 72.

FIG. 13 is an isolated view of single trailing weight assembly 170, which includes a securement band 174, connection cords 176, and two trailing weights 172.

FIG. 14 is a figure similar to FIG. 10, except that a double trailing weight assembly 70 is shown in phantom, attached to the hook assembly 220. Note that for illustrative purposes the hook assembly is shown in side elevation (which is also approximate its normal as-pulled position), but the trailing weight assembly 70 is shown in slight perspective view, in order to show the existence of the two weights. Note the curved dotted line with two arrows at the end, illustrating the adjustability of the weights assembly 70 (similar to that shown in FIG. 8).

FIG. 15 is a figure similar to FIG. 11, except that a single trailing weight assembly 170 is also shown attached to the hook assembly 320. Note the curved dotted line with two arrows at the end, illustrating the adjustability of the weights assembly 170 (similar to the adjustability shown in FIGS. 8 and 14).

FIG. 16 is a partial view of the “football” hook assembly 220, particularly showing the head portion, with dotted lines used to show the orientation of the relatively larger embedded hook wire and the relatively smaller embedded wire coil wire.

FIG. 17 is a partial view of the “swim jig” hook assembly 320, particularly showing the head portion, with dotted lines used to show the orientation of the relatively larger embedded hook wire and the relatively smaller embedded wire coil wire.

FIG. 18 is an illustrative view of a 3/8 oz. jig head with no trailing weight assembly falling from a position “A” to a position “B”. In this case, the overall jig (which is shown as including a “crawfish”-type trailer in dotted line) will tend to “fall forward” as shown, in that the forward end of the jig (the end being pulled) will fall first ahead of the rest of the jig, as shown in condition “B” of FIG. 16. In this situation, there is a risk that the jig will simply end up as an unnatural—looking “clump” at the water bottom. This is generally considered disadvantageous.

In FIG. 19, a trailing weight assembly 70, which weighs ¼ oz total (⅛ oz per side), has been added to the configuration of FIG. 18. The same ⅜ oz jig head is used from FIG. 18. In this situation, a flatter and actually slower fall is provided. This can be advantageous; this type of fall has been considered a more natural fall due to the flatter orientation of the jig upon descent, and a slower fall can give the bait more time to be noticed by the fish.

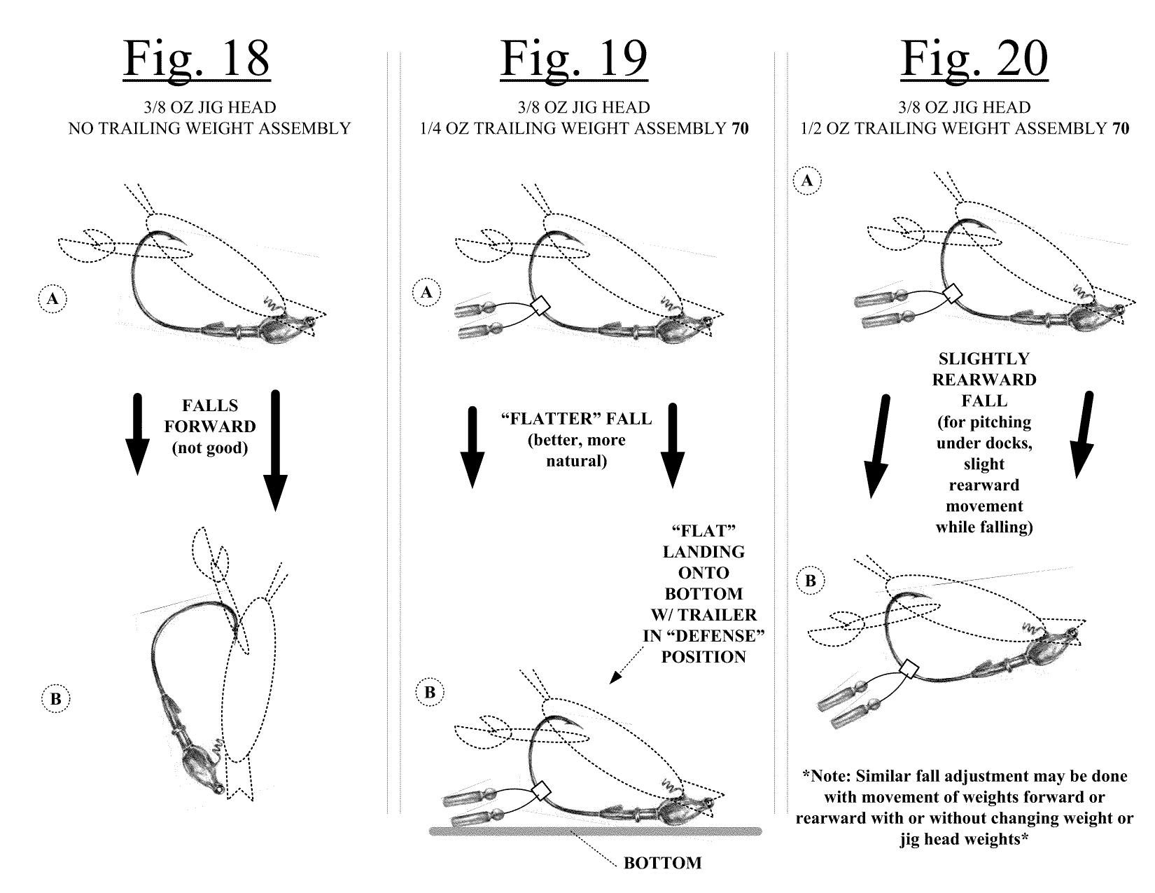

In FIG. 20, a trailing weight assembly has been added which weighs more than the one in FIGS. 19—½ oz. total (¼ oz. per side). The same ⅜ oz. jig head is used from FIGS. 18 and 19. In this situation, the jig tends to fall more rearward than in FIG. 17. This can be advantageous in this situation where an angler wishes to “pitch” the weight under a dock; such a more rearward falling would cause the jig to fall further under the dock as it falls.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Overview

This invention relates generally to a fishing jig, and in particular relates to a fishing jig that includes improved weighting features, improved trailer securement features, improved fall adjustment features, and other improved features.

Other details of the inventions disclosed herein are set forth below.

Element List

| 10 | Overall jig assembly | |
|---|---|---|
| | 20 | “Football” Hook assembly |

| | |
|---|---|
| 24 | Hook point |
| 28 | Wire coil |

| | |
|---|---|
| 40 | Trailer (crawfish embodiment) |

| | |
|---|---|
| 42 | Upper engagement portion |
| 44 | Lower engagement portion |

| | |
|---|---|
| 50 | Rattler Assembly |

| | |
|---|---|
| 52 | Rattles (2) |
| 54 | Securement band (1) (rubber or silicone rubber) |
| 56 | Connection cords (2) (rubber or silicone rubber) |

| | |
|---|---|
| 60 | Skirt assembly |

| | |
|---|---|
| 62 | Skirt strands (rubber or silicone rubber) |
| 64 | Strand retaining band (rubber or silicone rubber) |

| | |
|---|---|
| 70 | Trialing weight assembly |

| | |
|---|---|
| 72 | Weights (2) (lead) |
| 74 | Securement band (1) (rubber or silicone rubber) |
| 76 | Connection cords (2) (rubber or silicone rubber) |

| | |
|---|---|
| 120 | “Swim Jig” Hook assembly |

| | |
|---|---|
| 122 | Bare wire portion |
| 123 | “Turn back” point |
| 124 | Hook point |
| 126 | Hook eye |
| 128 | Wire coil |
| 130 | Lead section |

| | |
|---|---|
| 132 | Lead head |
| 134 | First cylindrical section |
| 136 | Collar |
| 138 | Second cylindrical section |
| 139 | Barbed section |
| 140 | Trailer (crawfish embodiment) |
| 170 | Single Trailing Weight Assembly |
| 220 | “Football” Hook assembly (third emb) |
| 320 | “Swim Jig” Hook assembly (fourth emb) |

### Detailed Description of Some Preferred Embodiments

A) General

Generally described, the invention relates at least in part to a jig assembly 10 which includes the following elements:

Hook assembly 20

Trailer 40

Rattler Assembly 50

Skirt Assembly 60

Trailing Weight Assembly 60

Reference is generally made to FIG. 4, which shows the overall jig assembly 10, which includes a hook assembly 20 (shown in dotted line), with a trailer 40, a rattler assembly 50, and a skirt assembly 60 all attached to the hook assembly 20. A dual trailing weight assembly 70 is typically attached, but is not shown in this figure.

It should be understood that other jig assemblies are contemplated within the spirit and scope of the present invention by replacing the hook assembly 20 with hook assemblies 120, 220, or 320, and/or by using or not using the rattlers, and/or by using any of the weight assemblies discussed herein.

The hook assembly 20 includes an improved wire coil portion 22, described in more detail later, which provides improved trailer retention and action.

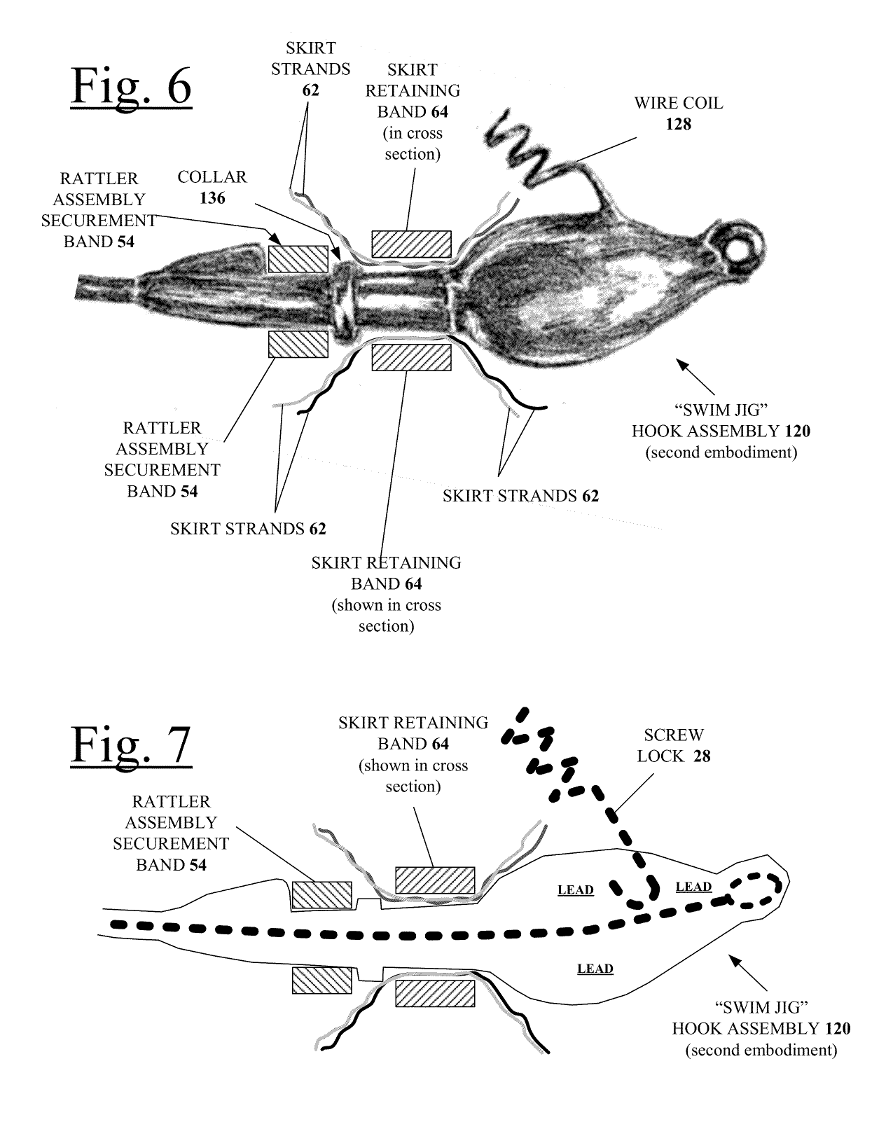

Also included is a new barb configuration such as identified in barbed section 39, which holds elements in place such as a rattler assembly (see FIG. 6).

Also included is are trailing weight assemblies such as 70 and 170, which provide improved features, including the variance of weights and the movement of said weights along the length of the jig, each providing variations in overall jig action.

B) Hook Assembly 20

The Hook Assembly 20 includes:

Bare Wire Portion 22

Hook Point 24

Hook Eye 26

Wire coil 28

Lead Section 30

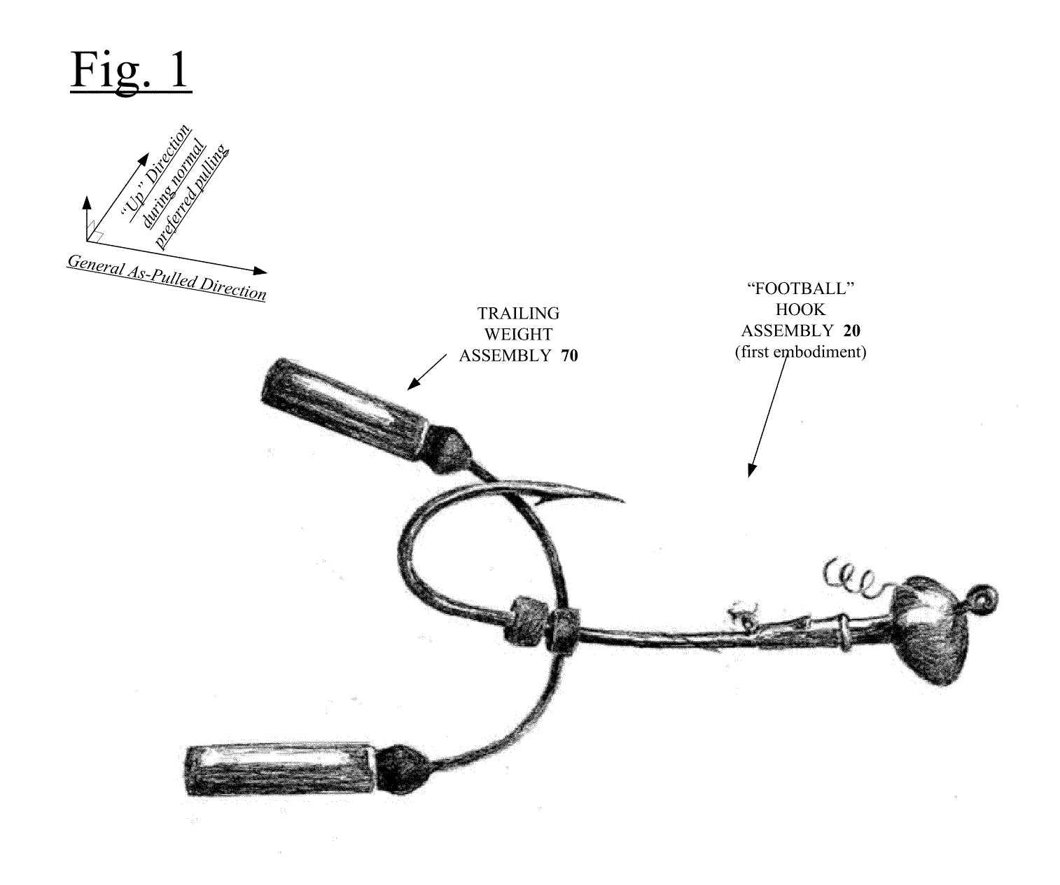

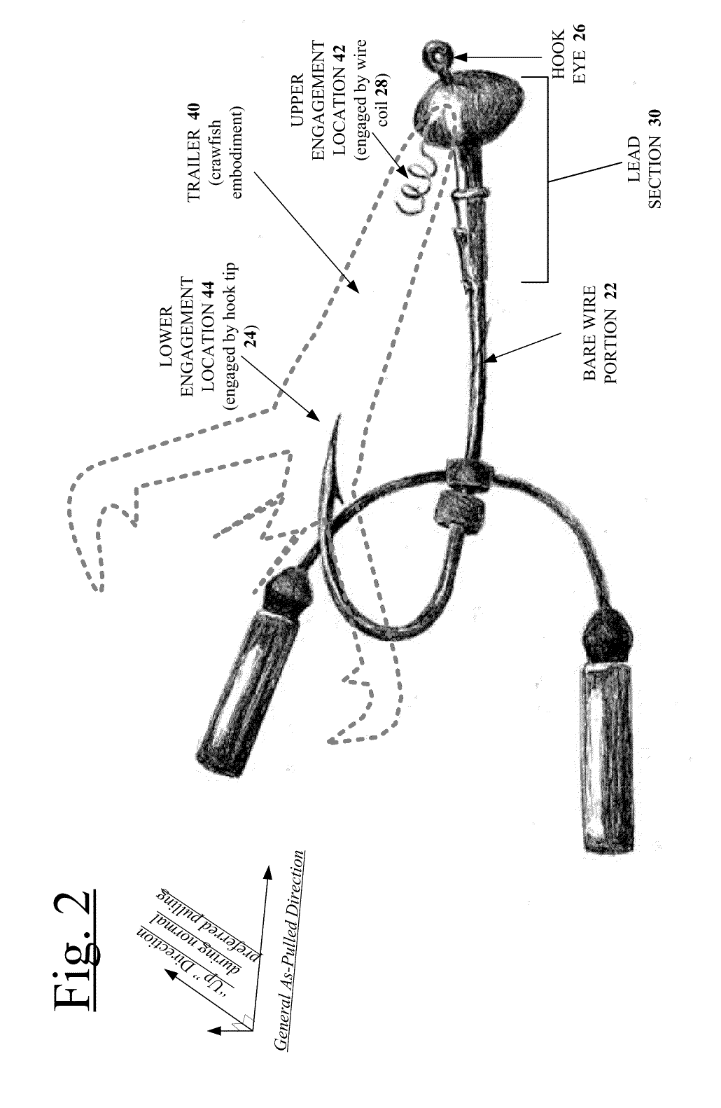

Reference is now also made to FIG. 1 for discussion. The bare wire portion 22 of the hook assembly 20 is the exposed portion of a wireformed fishing hook, which is formed of wire to form the hook eye 26, all the way to the hook point 24. A lead section 30 is molded to the hook, and captures one end of a wire coil 28. The lead section 30 is similar to the lead section 130 of another hook assembly 120.

“Swim Jig” Hook Assembly 120

The “Swim Jig” Hook Assembly 120 includes:

Bare Wire Portion 122

Hook Point 124

Hook Eye 126

Wire coil 128

Lead Section 130

The Lead Section 130 itself includes all of the following as an integral lead casting:

Lead Head 132

First Cylindrical Section 134

Collar 136

Second Cylindrical Section 138

Barbed Section 139

As noted earlier, the details of the lead section 130 are similar to the lead section of hook assembly 20, with the exception of the head shape.

The lead section 130 is poured from molten lead, such that the lead cools around and attached to the wireformed fishing hook and the wire coil 128. As may be seen in FIG. 7, the wire coil 128 has a curled back end which is embedded in the lead of the lead head 132 for better connection therewith. The hook shank within the lead can be similarly shaped or otherwise bent as needed.

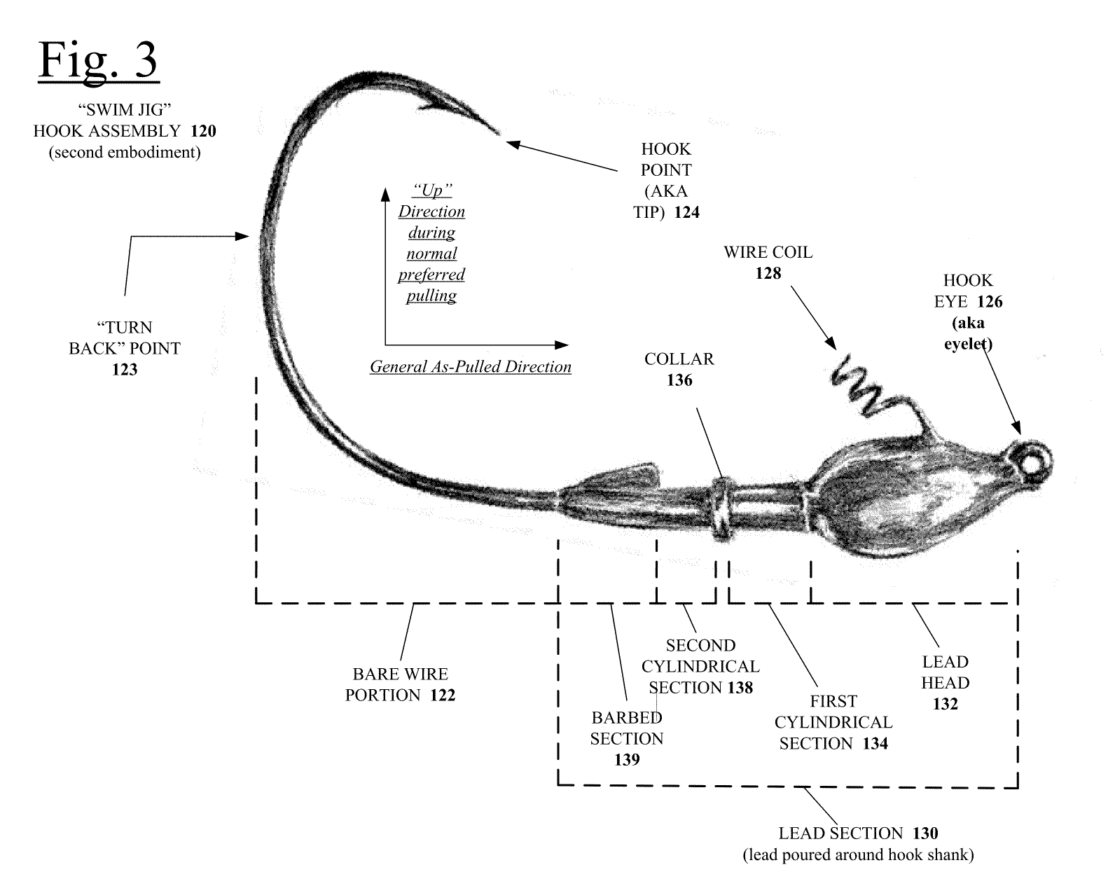

The lead head 132 of the lead section is shown in FIG. 3 as a second embodiment head, and as noted before is different from the first embodiment head 32 shown in FIG. 1 (for example).

The first cylindrical section 134 has a cylindrical outer surface, and is configured to accept and support a strand retaining band 164 therearound, such that skirt strands 132 can be attached to the hook assembly 120.

The collar 136 is between the first cylindrical section 134 and the second cylindrical section 138, and serves to retain the strand retaining band 164 from sliding away from the head.

The second cylindrical section 138 is between the collar 136 and the barbed section 139. The second cylindrical section 138 has a cylindrical outer surface, and is configured to support a rattler assembly retaining band 54 therearound (see FIG. 6), such that the rattler assembly 150 can be attached thereto.

The barbed section 139 is adjacent the second cylindrical section 138, and serves to retain the rattler assembly retaining band 54 from sliding away relative to the head (see FIG. 6).

Rattler Assembly 50

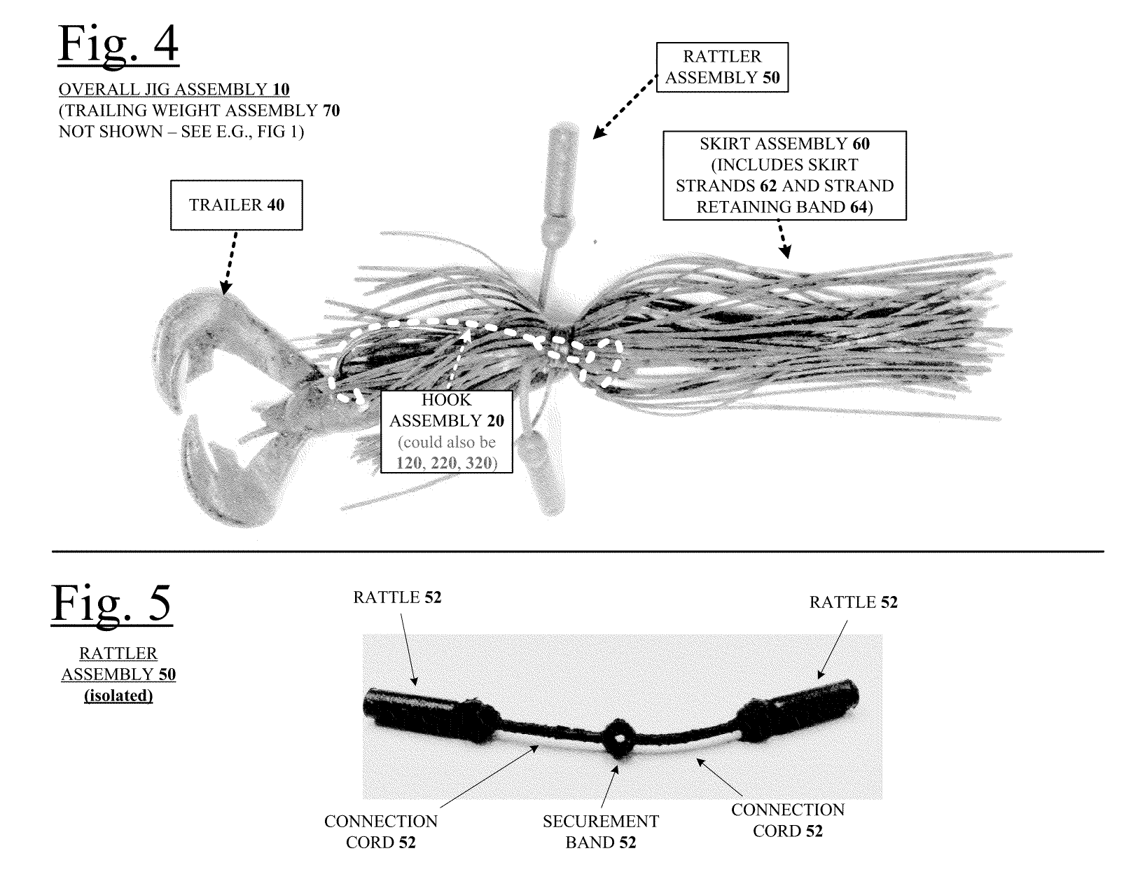

Referring now back to FIG. 4 and also to FIG. 5, the Rattler Assembly 50 itself includes:

Rattles 52

Securement Band 54

Connection Cords 56 (integral with securement band 54)

This is an assembly intended to provide a desirable “rattle” as the jig is in use. The rattles 52 consist of an enclosure (e.g. plastic) including plastic or metal beads or the like to cause a “rattle” when shaken. The securement band 54 and connection cords 56 are in one embodiment of unitary rubber, silicone rubber, or other suitable material. The securement band 54 is flexible to allow it to be slid in place over the barbed section 39 of the hook assembly 20. When in use the rattles are general on either side of the hook assembly 20 (or other assemblies 120, 220, 320).

Skirt Assembly 60

The skirt assembly 60 provides a desirable appearance to the jig 10. The use of skirt strands is generally known in the art, but the manner in which the skirt strands are attached is part of the invention. The skirt assembly 60 includes skirt strands 62, which are individual strands as known in the art, attached relative to the hook assembly 20 via the previously mentioned strand retaining band 64, which attaches as shown in FIG. 6. The strand retaining band 64 is a simple band of rubber or other flexible or other suitable material such as known in the art.

Trailing Weight Assembly 70

The trailing weight assembly 70 provides desirable action for the jig 10, or for a wide variety of other jigs or hooked elements.

The trailing weight assembly includes the following elements:

Two Weights 72

Securement band 74

Connection cords 76

Referring now again to FIG. 1, the trailing weight assembly 70 attaches to the bare wire portion of the hook assembly 20 via the securement band, such that the two weights are on either side of the hook as it is drawn through the water.

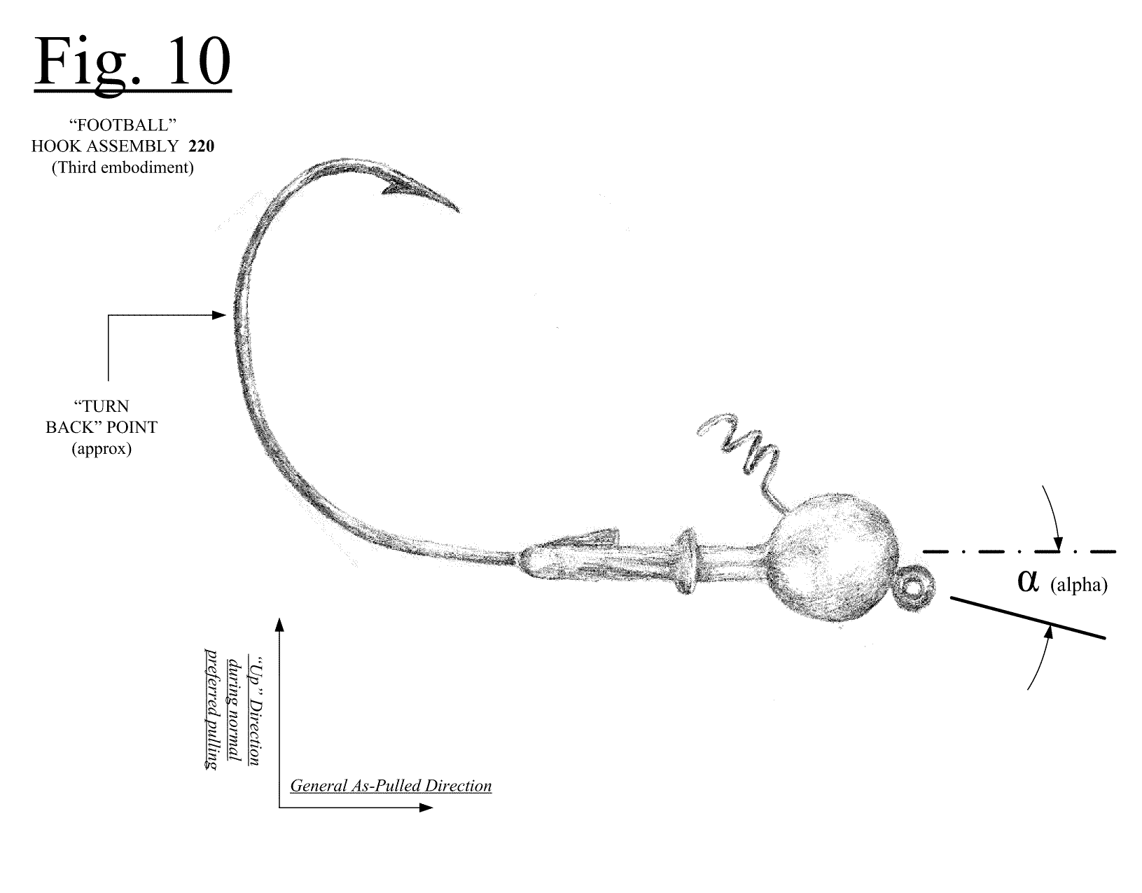

FIG. 9 is an isolated view of a weight 72 as it is attached to a connection cord 72. As may be seen the connection cord 76 includes a cup which snap-fits over a head defined by the weight 72. The weight 72 can be 1/8 oz., for example, and is configured to can be altered in the field by cutting it in half or another sub-portion, in order to lighten the weight.

It may be said that the two weight elements 72 are spaced apart and “on different sides of said plane of said hook”; as may be seen, the hook is generally symmetrical about a plane passing substantially through the center of the wire, though the hole in the eyelet and through the tip of the hook. When the hook is in normal preferred use, this can be referenced as the hook having two “sides” on either side of this vertical plane, with one weight on either side of the plane. This provides a vertical stability feature discussed elsewhere which tends to keep the hook/jog in an upright position.

Adjustability and Improved Action provided by Trailing Weight Assembly 70 As generally noted above, the trailing weight assembly 70 provides desirable action for the jig 10, or for a wide variety of other jigs or hooked elements. The rear weights, tending to pull down, add stability, tending to keep the hook/lure in an upright position at all times.

This is done by adjusting the position of the trailing weight assembly 70 along a length of bare wire portion of an associate applicable hook assembly or hook, or by adjusting the amount of weights included in the trailing weight assembly 70, or by a combination of the two.

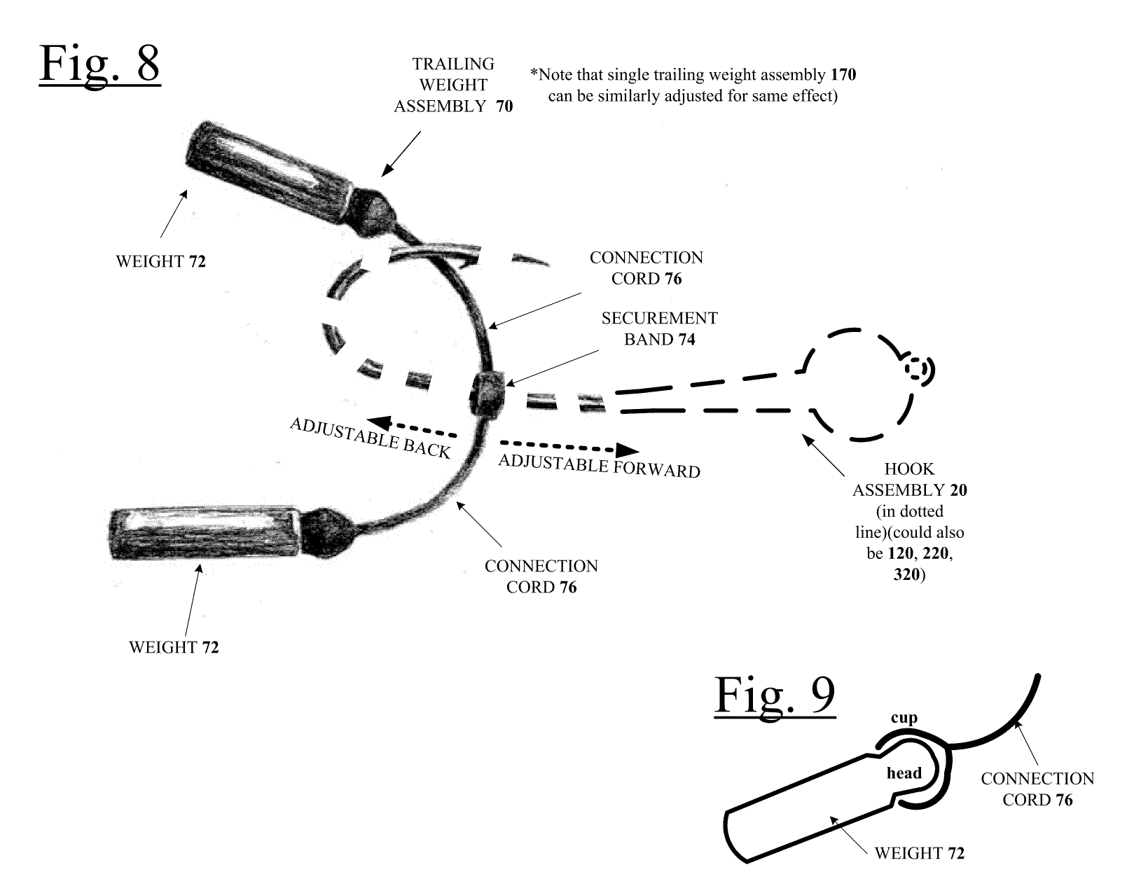

Reference is now made to FIG. 8 to show the adjustability of the position of the trailing weight assembly 70 along a length of bare wire portion of hook assembly 20 (although the same concept applies to hook assemblies 120, 220, or 320.

As noted earlier, a securement band 74 is used to secure the trailing weight assembly 70 to a length of bare wire portion of hook assembly 70. This securement band, made from a suitable rubber, plastic, or other suitable material, is configured to be moved along a length of bare wire portion of hook assembly 20 as shown by example in FIG. 8.

It may be understood that by moving the securement band 74 “forward” as shown in FIG. 8, a jig including the hook assembly will tend to dive more “forward-first” when not being pulled the water, whereas moving the securement band 74 “back” as shown in FIG. 8, the jig will tend to dive more “back-first”. Such a selection is an important part of at least one of the inventions herein, as this can make a difference between a strike or not to certain fish, at certain times. See also FIGS. 18-20 to see different fall characteristics.

Such “fore-aft” adjustability can be used in combination with the adjustability of the weight of the weights 72. As noted above, the weights 72 are configured to be detachable from their associated connection cords 76; this allows different weights to be attached (typically only differing in length), or to be left off altogether. Under another embodiment of the inventions, individual weights may be broken, otherwise severed, or completely removed to reduce their weight.

This combination of adjustability allows the trailing weight assembly 70 to add stability, keeping the jig in an upright position at all times, if so desired, by tending to make the jig fall flat, with equal weight front and rear, which also slows the descent of the jig.. By sliding the weights forward, the center of gravity of the jig is moved forward, thus the jig tends to fall more forward. By sliding the weights rearward, the center of gravity of the jig is moved rearward, thus the jig tends to fall more rearward.

Adjusting the jig for a flatter fall gives the bass time to get to the jig before it hits the bottom; the extra time could be the difference between a bite or not. Once the jig is on the bottom, it is in an upright, natural position, which would be considered food and the fish would strike it.

The following scenario is provided for example only. If a hook assembly 20 (aka jig head) that weighs ¼ ounces on its own is combined with a separate trailing weight assembly (eg 70 or 170) with the rear weight(s) totaling ½ ounces (e.g., two ¼ oz. weights or one at ½ ounces) it will be easy for the jig to fall backwards. If the weight on the front was ½ ounces and the weight on the rear was ½ ounces, it would tend to fall more level than the first jig, all else being the same. By moving the trailing weight assembly more forwardly or rearwardly in the second jig configuration, the second configuration overall jig could be “dialed in” to fall more forwardly or rearwardly as desired.

Note also that jig fall adjustment is also possible via changing the weight(s) of the trailing weight assembly (e.g., 70 or 170) without necessarily moving the weight assembly forward or rearward. Reference is now made to FIGS. 18-20. In FIG. 18, is it assumed that no trailing weight assembly is used, with a 3/8 oz jig head. In this case, the overall jig (which is shown as including a “crawfish”-type trailer in dotted line) will tend to “fall forward” from initial position “A” as shown, in that the forward end of the jig (the end being pulled) will fall ahead of the rest of the jig, as shown in condition “B”. In this situation, there is a risk that the jig will simply end up as an unnatural—looking “clump” at the water bottom. This is generally considered disadvantageous.

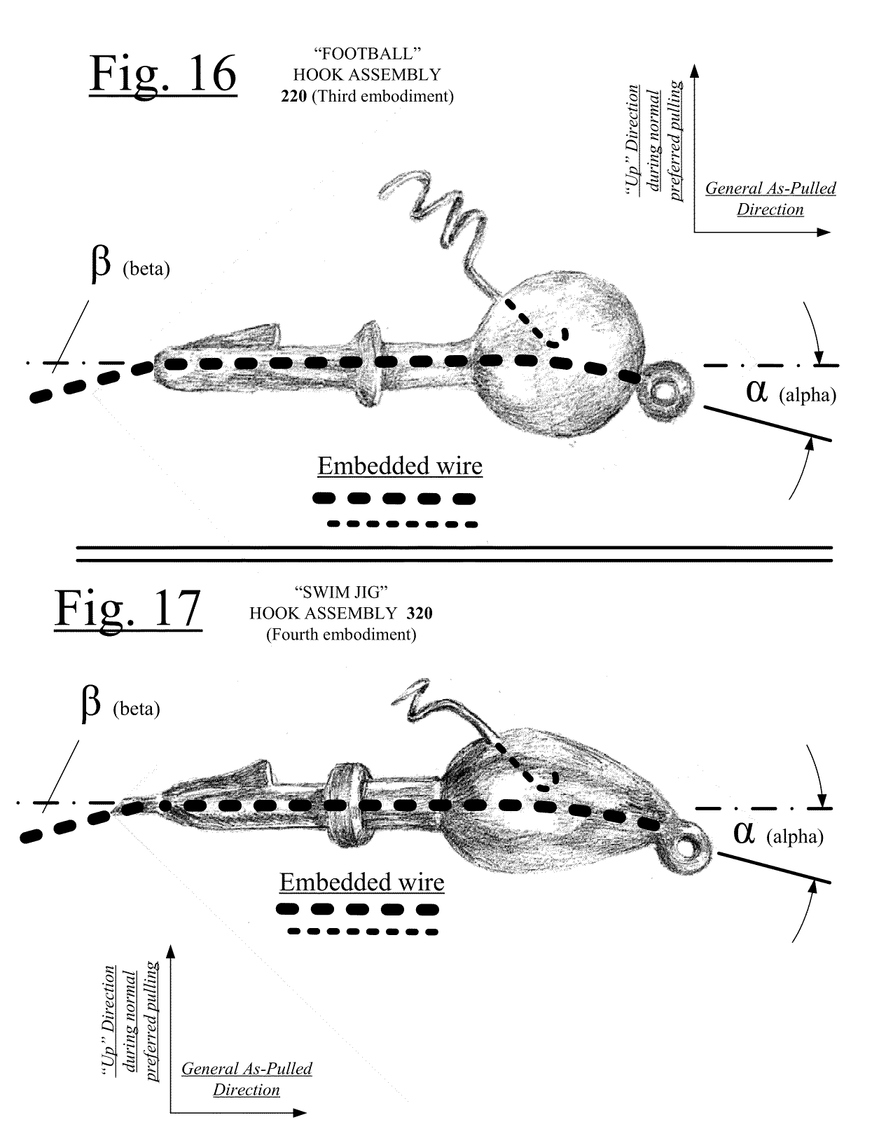

In FIG. 19, a trailing weight assembly has been added, which weighs ¼ oz total (⅛ oz per side). The same ⅜ oz jig head is used from FIG. 16. In this situation, a flatter and actually slower descent is provided. This can be advantageous; this type of fall has been considered a more natural fall due to the flatter orientation of the jig upon descent, and a slower fall can give the bait more time to be noticed by the fish.

In FIG. 20, a trailing weight assembly has been added, which weighs ½ oz. total (¼ oz. per side). The same ⅜ oz. jig head is used from FIGS. 16 and 17. In this situation, the jig tends to fall more rearward than in FIG. 17. This can be advantageous in this situation where an angler wishes to “pitch” the weight under an object (dock, log, etc.,); such a rearward falling would cause the jig to fall further under the object as it descends.

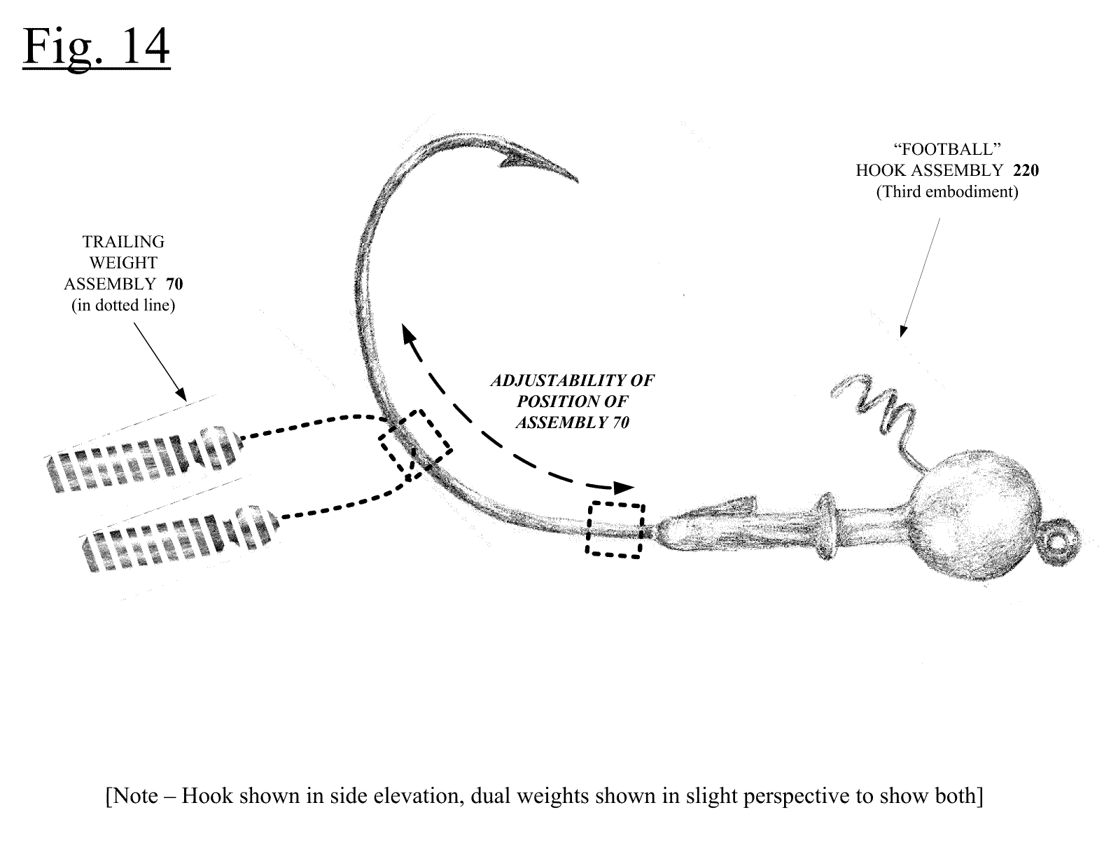

Note that the “adjustment” shown from FIG. 19 to FIG. 20 is not an adjustment of the trailing weight assembly along the shank of the hook to which it is attached (such as shown in FIG. 14). The adjustment shown is done via adjusting the weight of the weights included in the weight assembly. This can be done by substitution or by reducing the size of a weight, such as by cutting or the like. Note, however, that the “adjustment” shown from FIG. 19 to FIG. 20 could be done in combination with the adjustment shown in FIGS. 8 and 14, providing unlimited combinations. The fall characteristics of the a jig descending; forward, flat, or rearward are shown in FIGS. 18-20; although those figures show the use of differing weights for a given jig and trailing weight assembly position (when in position), those fall characteristics shown illustrate the manner in which fall may be modified. The advantageous “falling and landing in defensive position” of the jigs of FIGS. 19 and 20 cannot be overemphasized. Tests of such jigs show remarkable reality of the crawfish trailer, with the two “arms” of the crawfish waving as the rigs falls to the floor.

The weights also tend to stabilize the jig as is moves through the water, with the hook in an orientation generally upward. This reduces the chance of snagging, when the jig is on or near the bottom. Said another way, the dual weights tend to act as “training wheels” as the overall jig is pulled on or near the bottom and the weights touch the bottom. This “resistance to falling over sidewardly” feature is also apparent in the use of jigs with the trailing weight assembly 70 as well as the trailing weight assembly 170.

The use of trailing weights, which may be adjustable in size and/or position within the jig, provide for adjustment of the fall characteristics of a given jig for a given situation. As an example, all else being the same, movement of weights forward along the jig cause the jig to fall more forwardly, and vice versa. All else being the same, increasing the size of weights at a given position on the rear of the jig cause the jig to fall more rearwardly, and vice versa. This provides a rear weight that can be adjusted in size, shape, and position or completely removed and reused, without destroying the jig or weight system.

“Football” Hook Assembly 220

Reference is now made to FIG. 10, which is a side elevational view of a “football” hook assembly 220 (third embodiment). This assembly is similar to “football” hook assembly 20 (first embodiment) of FIG. 1, except that the wire encased in the lead is bent differently, as will be discussed later in reference to FIG. 16.

“Swim Jig” Hook Assembly 320

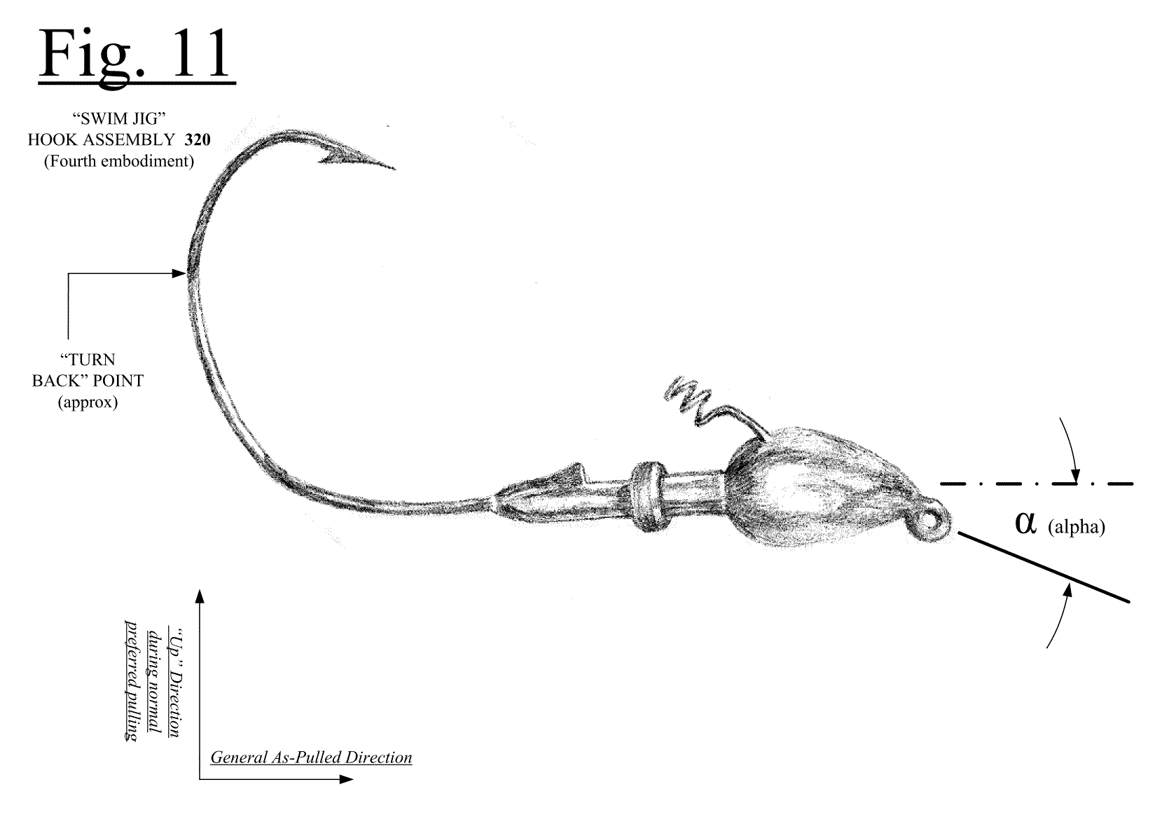

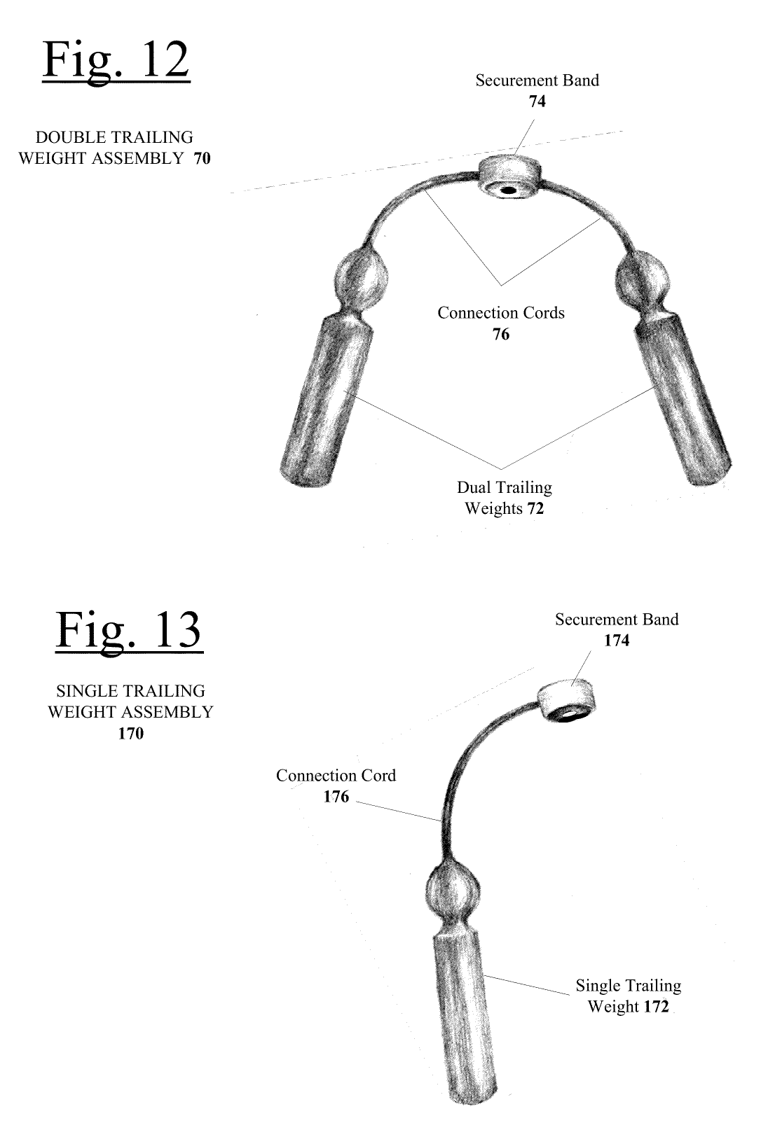

Reference is now made to FIG. 11, which is a side elevational view of a “swim jig” hook assembly 320 (fourth embodiment). This assembly is similar to “swim jig” hook assembly 120 (second embodiment) except that the wire encased in the lead is bent differently, as will be discussed later in reference to FIG. 17.

Note in this configuration the combination of unique elements, those elements being

Single Trailing Weight Assembly 170

Reference is now made to FIG. 13, which is an isolated view of single trailing weight assembly 170, which includes a securement band 174, connection cords 176, and two trailing weights 172. The securement band 174 works much like the previously-described securement band 74.

Trailing Weight Assembly 170

Reference is now made to FIG. 13, which is an isolated view of single trailing weight assembly 170, which includes a securement band 174, connection cords 176, and two trailing weights 172.

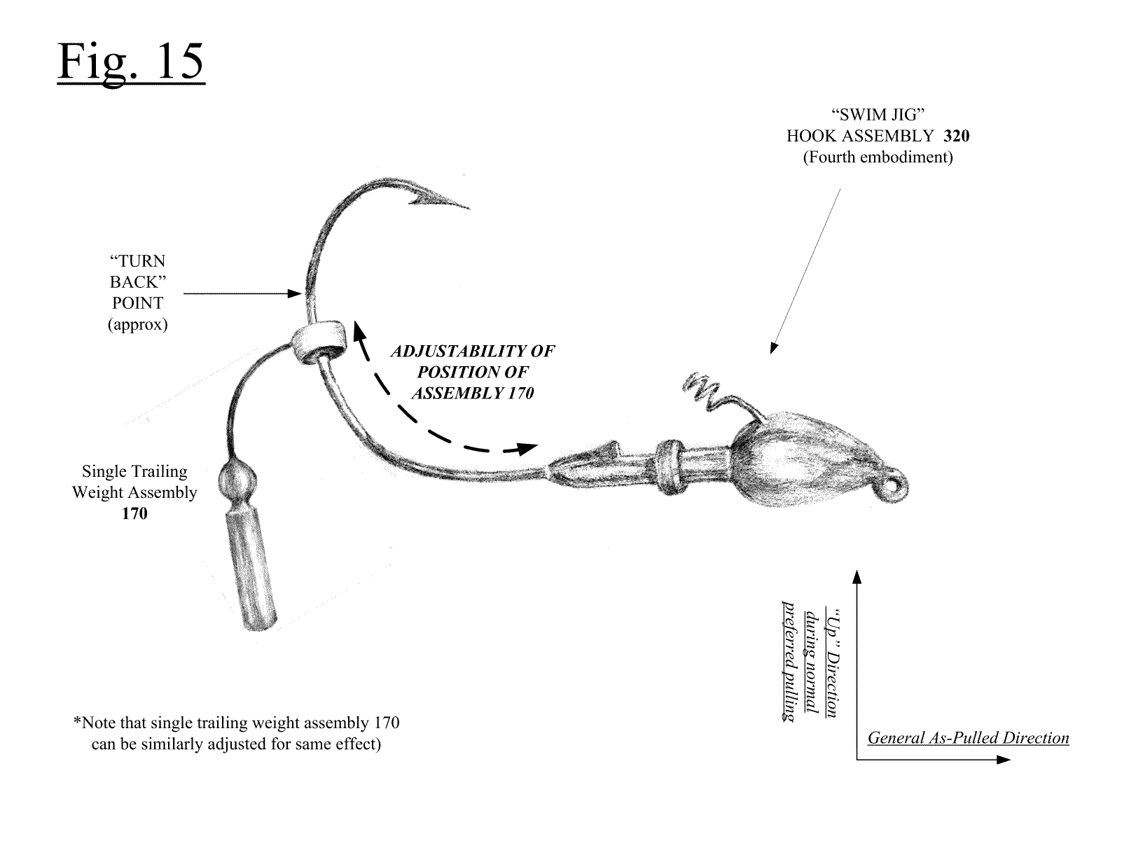

Reference is now made also to FIG. 15, which shows a single trailing weight assembly 170 attached to the hook assembly 320. Note the curved dotted line with two arrows at the end, illustrating the adjustability of the double (aka “dual”) trailing weight assembly 70 shown in FIGS. 8 and 14). This adjustability provides the same type of advantages as described before in reference to trailing weight assembly 70.

The trailing weight assembly 170 provides desirable action for the jig 10, or for a wide variety of other jigs or hooked elements.

Redesigned Hook with Angles “Alpha” α and “Beta” β

Reference is now made to FIGS. 16 and 17, to show details on the manner in which the hook wire is redesigned in hook assemblies 220 and 320.

Assuming the main part of the hook wire in the middle of the lead is straight and is the base “zero” axis for this discussion, both the Alpha angles are approximately 20 degrees from the base axis, and the Beta angles are approximately 10 degrees from the base axis. Said another way, with these hooks, the hook at the eye is about 20 degrees down, then goes straight, then drops about 10 degrees down, then starts in a upward wide bend coming back around, with the hook point, pointing directly at the wire coil. The reason the hook drops at the eye, is to reduce getting hung or stuck on objects at the bottom, plus, when picked up or moved forward, the tail lowers and the head rises. After the straight part, the lower bend is for keeping the back of the lure on or close to the bottom to reduce hanging, plus it opens the gap between the lower part of the hook and the hook point making it wider for a better hook set, penetrating the mouth of the fish.

This combination provides a new and improved wide gap hook with the eye lowered 20 degrees down, for upward movement and the rear of the hook lowered 10 degrees to open the hook gap more, to make the jig in FIG. 10-11 more uniform or profile and weedless. The “dropped” line attachment eye, which gives an upward movement when the lure is pulled in, also helps with a better hook set, as the opening up of the hook gap enables the hook to penetrate the fish's mouth easier and better.

Combination of Wire Coil and Skirt Mounting Collar to Provide Weedless Configuration with Skirt

Note that all of the jigs shown in this application show a unique combination of elements, namely the combination of these three elements:

Some type of head (football or swim head)

Skirt mounting section extending from head

Wire coil extending from head

Although skirt mounting sections extending from a jig head are known (e.g., in swim jigs), it is submitted that the addition of a wire coil has not been so included. Along the same lines, football headed jigs have been known to include wire coils, but it is submitted that the addition of a skirt mounting sections extending from a jig head is not known. The combination of these elements is submitted to provide an improved jig which can include a skirt, and position a trailer between the wire coil and the hook point.

Miscellaneous Comments

Surgical pitching is known as dropping a (jig) in an exact spot, with a fast decent (fall), thus causing what is to be considered a (reaction bite) done by the fish's reflexes. This is an art, and only one way to use a jig. Most jigs are fished bouncing the lure on the bottom as you drag it in. Some jigs are fished simply pulling it through the water; this is called “swimming” the jig. FIGS. 16-17 show a new jig design that has never been produced. FIGS. 16-17 show that adding FIG. 8 in relationship to FIG. 14 and FIGS. 19-20. This demonstrates that this new design produces a jig to perform in a new, (uncharted category).

It has been filmed and documented that shows a jig hitting the surface and falling to the bottom, with the relationship to a fish with in 20 feet where the jig entered the water. In a water depth of 15 feet, a (standard) jig was pitched into the water within 20 feet of a fish (bass). The jig dropped straight to the bottom, the fish heard the splash as the object (jig) enter the water and felt the movement with its lateral line. The fish (bass) swam over to where the object (jig) entered and the movement of the object (jig) dropping. By the time the fish (bass) reached the point of decent, the object (jig) was already lying on the bottom, and looked like a piece of debris (trash) and the fish (swam) off. This new jig demonstrates that, it's not a modification, but a new jig, proven by its performance by falling slower and landing on the bottom in a natural position. Also demonstrates the ability to easily alter the decent direction and speed, as fishing condition change, uses the same jig.

Note that a second (unnumbered) securement band is shown in FIG. 1; this may be used as needed in any of the configurations herein to better secure the rear weight.

A water body “bottom” is the floor of a body of water such as a lake, stream, pond, etc. Otherwise known as “the bottom”.

Note that under an alternate configuration of the invention, a weight with a hole in it could be used with a connection element without and inmediate elongate flexible portion. , filled with an interior rubber collar insert itself halving a smaller hold big enough to get around the barb, could be used to attach to the hook, without the use of an elongate connection between the hook and the weight. Said another way, a weight could be attached more directly to the bare wire portion of the hook. This weight could be adjusted along the hook wire length due to the movable attachment

Note that an elongate hook portion of a hook element can be straight, or curved; an item may be elongate but still including an arcuate longitudinal axis.

Materials

The materials are relatively conventional.

The wire coils 28, 128 are stainless steel or another suitable material.

The securement band 54 and connection cords 56 and similar components in similar jigs are configured of rubber or silicone rubber.

The skirt strands 62 and similar components in similar jigs are conventional and configured of rubber or silicone rubber.

The skirt retaining band 64 and similar components in similar jigs are configured of rubber or silicone rubber.

The weights 72, 172 are lead, steel, or another suitably heavy material.

The securement band 74 and connection cords 76 and similar components in similar jigs are configured of rubber or silicone rubber.

The hook itself can be wire formed according to the art, or comprised of another suitable elongate bent member.

Aspects

Thus it may be seen that the present inventions provide an improved fishing jig. It may also be seen that the present inventions provide an improved fishing jig having improved response features. It may also be seen that the present inventions provide an improved fishing jig having improved weedless features. It may also be seen that the present inventions provide an improved fishing jig having improved use features.

Conclusion

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A fishing element configured to be pulled along a pulling axis, said fishing element comprising:
a hook element, said hook element including an elongate hook portion having a component along said pulling axis, said elongate hook portion including forward and rearward segments being at differing positions relative to said pulling axis, said forward hook shank segment being positioned more forwardly than said forward hook shank segment;
a trailing weight element; and
a connection element for connecting said hook relative to the said weight, said connection element including an connecting segment configured to be movably attached relative to either of said forward and rearward segments,
such that the center of gravity of said fishing element can be adjusted along the length of said pulling axis by moving said connection element back and forth between attachment with said forward and rearward segments.

2. The fishing element as claimed in claim 1, wherein said weight element is the only weight element attached to said connection element.

3. The fishing element as claimed in claim 1, wherein said connection element includes an intermediate elongate flexible portion which interconnects its connecting segment to said trailing weight element, such that the weight is spaced from the hook.

4. The fishing element as claimed in claim 3, wherein said connector attaches to the hook between the hook eye and the turnback point of the hook, such that gravity on the weights tends to keeps the hook point up.

5. The fishing element as claimed in claim 1, wherein said connector attaches to the hook between the hook eye and the turnback point of the hook, such that gravity on the weights tends to keeps the hook point up.

6. The fishing element as claimed in claim 1,
wherein said elongate elongate hook portion lies substantially in a plane;
wherein said weight element is a first weight element attached to said connection element, and
further comprising a second weight element attached to said connection element such that two weight elements are spaced apart and on different sides of said plane of said hook.

7. The fishing element as claimed in claim 6, wherein said each connection element includes an intermediate elongate flexible portion which interconnects its connecting segment to said trailing weight element, such that each weight is spaced from the hook.

8. A fishing element configured to be pulled along a pulling axis, said fishing element comprising:
a hook element, said hook element including an eye, and also including an elongate hook portion spaced from said eye and having a component along said pulling axis, said elongate hook portion including forward and rearward segments being at differing positions relative to said pulling axis, said forward hook shank segment being positioned more forwardly than said forward hook shank segment;
a jig head of a predetermined weight, said jig head attached to said hook element proximate said eye
a trailing weight element; and
a connection element for connecting said hook relative to the said weight, said connection element including a elongate hook portion connecting end configured to be movably attached relative to either of said forward and rearward segments,
such that the center of gravity of said fishing element can be adjusted along the length of said pulling axis by moving said connection element back and forth between attachment with said forward and rearward segments.

9. The fishing element as claimed in claim 8, wherein said weight element is the only weight element attached to said connection element.

10. The fishing element as claimed in claim 8, wherein said connection element includes an intermediate elongate flexible portion which interconnects its connecting segment to said trailing weight element, such that the weight is spaced from the hook.

11. The fishing element as claimed in claim 10, wherein said connector attaches to the hook between the hook eye and the turnback point of the hook, such that gravity on the weights tends to keeps the hook point up.

12. The fishing element as claimed in claim 8, wherein said connector attaches to the hook between the hook eye and the turnback point of the hook, such that gravity on the weights tends to keeps the hook point up.

13. The fishing element as claimed in claim 8,
wherein said elongate hook portion lies substantially in a plane;
wherein said weight element is a first weight element attached to said connection element, and
further comprising a second weight element attached to said connection element such that two weight elements are spaced apart and on different sides of said plane of said hook.

14. The fishing element as claimed in claim 13, wherein said each connection element includes an intermediate elongate flexible portion which interconnects its connecting segment to said trailing weight element, such that each weight is spaced from the hook.

15. A method of adjusting the drop characteristics of a fishing element configured to be cast into water, allowed to drop, and then pulled along a pulling axis, said method comprising the steps of:
A) Providing a fishing element, said fishing element comprising:
1) a hook element, said hook element including an eye, and also including an elongate hook portion spaced from said eye and having a component along said pulling axis, said elongate hook portion including forward and rearward segments being at differing positions relative to said pulling axis, said forward hook shank segment being positioned more forwardly than said forward hook shank segment;
2) a jig head of a predetermined weight, said jig head attached to said hook element proximate said eye;
3) a trailing weight element; and
4) a connection element connecting said hook relative to the said weight, said connection element including an elongate hook portion connecting portion configured to be movably attached relative to either of said forward and rearward segments; and
B) adjusting the fall of said fishing element by adjusting the position of said connection element back and forth along the length of said elongate hook portion.

16. The method of claim 15, wherein said Step “B” also includes the step of adjusting the weight of the trailing weight element.

17. A fishing element configured to be pulled along a pulling axis, said fishing element comprising:
a hook element comprised of an elongate bent member, said hook element including an eye, a shank portion, a bend portion and a point, said elongate bent member extending from said eye at one end, to said shank portion, to said bend portion, and terminating in said point at its other end;
a jig head of a predetermined weight, said jig head attached to said hook element adjacent said eye;
a skirt mounting section attached to said hook element, said skirt mounting section mounted adjacent said jig head such that said jig head is intermediate said skirt mounting section and said eye;
a skirt for attaching to said skirt mounting section; and
a wire coil extending from said jig head generally towards said hook point, said wire coil configured for engaging a trailer.

18. The fishing element as claimed in claim 17, further comprising a trailer having and elongate portion with two ends, one end engaged with said wire coil and one end engaged with said hook point, such that said trailer provides a weedless feature.

19. The fishing element as claimed in claim 18, further comprising a crawfish-shaped trailer having and elongate portion with two ends, one end engaged with said wire coil and one end engaged with said hook point, such that said trailer provides a weedless feature, and such that said crawfish shape tends to imitate a “defensive” crawfish position when said fishing element is positioned on the water body bottom.

20. The fishing element as claimed in claim 18, wherein said jig head is one of a swim jig head or a “football” head.

21. The fishing element as claimed in claim 18, wherein said hook element includes a substantially straight wire shank portion, around which said jig head is molded, with said eye extending away from one side of said jig head at a 10 degree angle away from the bend side of the hook, and wherein hook element includes a wire portion extending out of the other side of said molded jig head at a 20 degree angle, such that the hook at the eye is about 20 degrees down, the wire then goes straight, then drops about 10 degrees down, then starts in a upward wide bend coming back around, with the hook point pointing directly at the wire coil.

22. A fishing element configured to be pulled along a pulling axis, said fishing element comprising:
a hook element comprised of an elongate bent member, said hook element including an eye, a shank portion, a bend portion and a point, said elongate bent member extending from said eye, to said shank portion, to said bend portion, and terminating in said point;
a jig head of a predetermined weight, said jig head attached to said hook element adjacent said eye;
a skirt mounting section attached to said hook element, said skirt mounting section mounted adjacent said jig head such that said jig head is intermediate said skirt mounting section and said eye;
a skirt for attaching to said skirt mounting section; and
a wire coil extending from said jig head generally towards said hook point, said wire coil configured for engaging a trailer.
